(19) United States
(12) Patent Application Publication
(10) Pub. No.: US 2004/0025423 A1
(43) Pub. Date: Feb. 12, 2004

(54) Method and cover for grass protection and restoration and for seed germination

(76) Inventor: Peter Hinsperger, Mississauga (CA)

Correspondence Address: McFadden, Fincham, Suit 606, 225 Metcalfe Street, Ottawa, ON, K2P 1P9, CA

(21) Appl. No.: 10/600,436

(22) Filed: Jun. 23, 2003

Related U.S. Application Data
(63) Continuation of application No. 10/075,280, filed on Feb. 15, 2002, now abandoned.
(63) Continuation-in-part of application No. 10/075,280, filed on Feb. 15, 2002, now abandoned.

(30) Foreign Application Priority Data
Nov. 30, 2001 (CA) 2,364,195

(51) Int. Cl. A01G 7/00

(52) U.S. Cl. 47/9

(57) ABSTRACT

A protective heat absorbing and heat reflective composite comprising an open mesh weave of thermoplastic material, the weave having warp and weft strips forming a substantially thin uniform layer having opposed major surfaces, the layer having on one surface thereof a heat absorbing lace coating and on the other surface thereof a heat reflective discontinuous or intermittent coating.

This is a continuation of Ser. No. 10/075,280 filed Feb. 15, 2002.

### FIELD OF THE INVENTION

The present invention relates to a method to protect and to enhance the growth of outdoor grass areas; in addition, the method and product also find use for other earth substrates such as gardens (e.g. vegetable gardens), and the like. General wear and tear of grass substrates, such as golf greens, athletic fields, parks, and the like, requires considerable expense and effort to maintain and repair.

A particular feature of the present invention is to protect the grass and grass roots from desiccation and at the same time optimize the growth of the grass. This is accomplished by covering the area of grass to be protected with an insulating cover which permits the passage of air and moisture and sunlight while guarding against harsh elements which may destroy the grassed area. An improved insulating cover allows for the proper heat absorption and heat reflection properties to be directed to the grass thereby optimizing growth of the grass.

### BACKGROUND ART

There have been several attempts to protect outdoor grass from desiccation and winter kill and covering the area to be protected is well known in the art. Specifically, applicant's Canadian patent serial number 1,272, 027 describes a woven insulated cover which is particularly well suited for use to preserve and protect grassed areas from winter kill. The present invention improves upon the features of the '027 patent in the manner described below.

In the case of gardens such as vegetable gardens, there is a need to maintain higher earth temperatures particularly for over the winter crops, germination of seeds and the like. At present, while there are certain types of air and water permeable products on the market, none of those products are effective to enhance earth temperatures and promote early development of seeds or over winter crops.

### SUMMARY OF THE INVENTION

In accordance with one aspect of this invention there is provided an improved protective composite which is suitable for use in the above described fields, and which provides heat reflective properties and heat adsorption properties in order to impart improved results to turf, lawn, garden and like substrate surfaces.

In greater detail, in accordance with one aspect of this invention, there is provided a protective heat absorbing and heat reflective composite comprising an open mesh weave of thermoplastic material, the weave having warp and weft strips forming a substantially uniform layer having opposed major surfaces, the layer having on one surface thereof a heat absorbing discontinuous or intermittent coating, such as a lace coating, and on the other surface a heat reflective lace coating.

In a preferred embodiment of the present invention, the protective material is a continuous sheet of a one-piece “open” weave thermoplastic material which may be provided with suitable additives conventional in the industry as represented by ultraviolet stabilizers, extenders, anti-oxidants and the like. Properties of the product of the present invention include the fact that it is moisture permeable when subjected to a water pressure as would be encountered in a rainfall, or under conditions of watering an area with a hose but at the same time, retaining moisture beneath the protective cover without permitting the same to be evaporated. In a like manner, the product permits the passage of atmospheric air under normal atmospheric conditions so that the cover “breathes” but at the same time, prevents abnormal atmospheric conditions e.g. atmospheric wind from penetrating to any extent through the protective cover. In the present invention, the cover is a plastic material which can be semi-translucent.

It is desirable that the protective layer comprises an open-mesh weave of thermoplastic material, the open-mesh weave comprising one or more substantially thin uniform layers of intersecting strands of thermoplastic material forming a substantially closed formation when in a lay-flat condition having opposed major surfaces, the open-mesh weave of thermoplastic material having a plurality of slits formed by intersecting strands of the open-mesh weave thereby permitting the passage of moisture therethrough upon moisture pressure against the material.

The plastic material forming the strips of said composite can be any suitable material such as a polyolefin, the preferred polyolefin is a polyethylene or polypropylene and the lace coating is a polyolefin such as a polyethylene compatible with the polyethylene strip.

The thickness of the core material used in the method of the present invention is not critical per se as long as the product remains flexible to the extent that water is generally able to permeate the surface; the thickness can be e.g. from 1 mil to e.g. 30 mils. or more if desired. The lace coating may likewise be relatively thin so that an overall lightweight material may be employed. For given types of application, it may be desirable to provide a border surrounding the sheet material to provide an integral product; also, if desired the lace coating material may be extruded or otherwise bonded to the mesh woven material. The thickness of each coating may vary considerably depending on the type of material. Typically, preferred materials are thermoplastic in nature and by way of example such lace coatings may be a polyolefin such as polyethylene, polypropylene, co-polymers, etc.

One component of the composite of the present invention is a heat absorbing layer; this may be achieved by utilizing a discontinuous or intermittent coating, such as a lace coating which may be of an irregular pattern and may be formed from heat absorbing material or a material having a heat absorbing component such as colour-coated material. In other words, the heat absorbing characteristics can be achieved by either selecting a material which has the capability of absorbing heat from the atmosphere or alternatively, by utilizing a colouring agent of a suitable characteristic which absorbs the energy emitted via the normal spectrum of light waves. Thus, for example, suitable coatings may be formed from polymeric materials; these coatings may be or are desirably of an irregular pattern as applied to the woven intermediate layer. Most desirably this coating may only cover between 5-60% of the woven layer on each face thereof, desirably 10 to 40% on each face thereof. The coating may be applied by suitable conventional techniques such as calendering, spraying, co-extrusion, etc.

Another component of the composite of the present invention is a heat reflecting layer on the opposing surface. The lace coating may be of an irregular pattern and streams linearly across the opposing surface in a like manner to the opposing side. Reflective characteristics are produced, for example, by applying a colouring agent to the surface area from the normal light spectrum having heat specular properties such as white, silver, gold, bronze, etc. Another example, of producing reflective properties from the lace coating is when the coating is of a colour from the normal light spectrum which simultaneously absorbs heat and releases in the desirable direction. Thus, for example, suitable coatings may be formed from polymeric materials; these coatings may be or are desirably of an irregular pattern as applied to the woven intermediate layer. Most desirably this coating may only cover between 5-60% of the woven layer on each face thereof, desirably 10 to 40% on each face thereof. The coating may be applied by suitable conventional techniques such as calendering, spraying, co-extrusion, etc.

Given that a lace coating is applied to each major face of the scrim or woven core, depending on the degree of overlap of the lace coatings on one surface with the other, the total coverage by both lace coatings may vary considerably. For example, by the lace coatings being applied to identical opposed layers on the woven core, the total coverage of the lace coatings for both major surfaces will be equal to the individual amount applied to each face. On the other hand, by varying the extent and location of the lace coating on one face relative to another face, the total coverage of the combined lace coating can increase considerably. Thus, the total coverage of the lace coatings can be as low as 5% of the total surface of the products of the present invention or significantly higher (e.g. 80% or more) when the lace coatings do not overlap each other to any significant extent.

In another embodiment of the present invention, there is provided a method of forming a heat absorbing and heat reflective composite layer which comprises the steps of providing an opening-mesh weave of thermoplastic material in which the material has warp and weft strips forming a substantially uniform layer and having opposed major surfaces; the open-mesh weave has openings of a size sufficient to permit the passage of water therethrough; coating one of the surfaces with a lace coating having heat reflective properties; and, coating the other surface with a lace coating having heat absorbing properties.

Additionally, a preferred embodiment of the present invention includes a method for protecting or enhancing turf, lawn or like substrate comprising: applying to a substrate a protective composite layer, the composite comprising an open mesh weave of thermoplastic material, the weave having warp and weft strips forming a substantially uniform layer having opposed major surfaces, the layer having on one surface thereof a heat absorbing lace coating and on the other surface a heat reflective lace coating; the composite being applied to the substrate with a heat absorption layer forming an outer face and the heat reflective layer being in contact with the substrate; releasably securing the protective layer to the area; and removing the protective layer when protection is not desired.

If desired, one or more reinforcing layers can also be included in the product where very thin products are used. Such a reinforcing layer can strengthen the product as desired, particularly for large products covering large substrates. Such reinforcing layers can be in the form of reinforcing scrims incorporated into the product on one or both sides, desirably below the lace on the face. Reinforcing scrim layers are known in various arts; they may be incorporated into the product on an in-line basis when the product is manufactured, or by extrusion, coating or like techniques. Any reinforcing layer, should not reduce the total slit availability of the material to close off all of the slit apertures between adjacent strands; it may contribute to a reduced slit availability where desired to thereby provide different characteristics for the woven material.

The products of the present invention are particularly suitable for use on lawns, golf greens, or other turf applications where it is desired to control and enhance the ambient temperature of the turf or like substrate. By way of example, golf greens frequently employ protective covering layers for wintering purposes; by utilizing the cover of the present invention, not only is moisture permitted to reach the substrate, and be ventilated, but due to the heat reflective layer, heat can be transferred to the substrate particularly for Spring-time application. Likewise the heat temperature of the substrate can be enhanced due to the heat reflective layer of the product and its function of reflecting radiated heat from the substrate back into the substrate. It will be obvious that different degrees of heat absorption and heat radiation can be achieved for different purposes in the products of the present invention by varying the amount of intensity of the heat absorption and heat reflective layers thus permitting products to be tailored for different applications and locations.

According to another aspect of the present invention, there is provided a cover for grass protection comprising a composite layer composed of an open mesh weave of thermoplastic material, the weave having warp and weft strips forming a substantially thin uniform layer having opposed surfaces, the mesh defining individual slits extending through the layer, a discontinuous heat absorbing layer on one of the opposed surfaces, and a discontinuous heat reflective layer on the other of the opposed surfaces.

In another aspect of the present invention, there is provided a method of forming a heat absorbing and heat reflective composite layer comprising the steps of providing an opening-mesh weave of thermoplastic material in which the material has warp and weft strips forming a substantially uniform layer and having opposed major surfaces, the open-mesh weave has openings of a size sufficient to permit the passage of water therethrough, coating one of the surfaces with a discontinuous or intermittent coating having heat reflective properties, and, coating the other the surface with a discontinuous or intermittent coating having heat absorbing properties.

In yet another aspect of the present invention, there is provided a method for protecting or enhancing turf, lawn, garden or other substrate comprising applying to the substrate a protective layer of a composite, th composit comprising an open mesh weave of thermoplastic material, the weave having warp and weft strips forming a substantially uniform layer having opposed major surfaces, the layer having on one surface thereof a heat absorbing discontinuous or intermittent coating and on the other surface a heat reflective discontinuous or intermittent coating, the composite being applied to the substrate with the heat absorption layer forming an outer face and the heat reflective layer being in contact with the substrate, releasably securing the protective layer to the substrate, and, removing the protective layer when protection is not desired.

### BRIEF DESCRIPTION OF THE DRAWINGS

Having thus generally described the present invention, reference will now be made to the accompanying drawings which comprise:

FIG. 1 is an elevated planar view of the present invention in use over a golf green;

FIG. 2 is a cross-sectional view of the present invention;

FIG. 3 is an enlarged top view illustrating the lace coating and which is similar to the bottom view.

### DETAILED DESCRIPTION OF THE PREFERRED EMBODIMENT

The invention is particularly applicable for protecting environmentally sensitive areas such as turf or grass areas where, for example, certain selected portions of such turf or grass must be protected. Typically, this may occur, for example, in natural grass baseball stadiums where the infield is a specially groomed surface or in the case of lawn bowling where the lawn bowl lanes are required to have special turf characteristics and similarly at golf courses where golf greens are maintained to higher standards compared to the balance of the playing area. In such cases, a very dense and normally different type of grass vegetation may be employed compared to adjacent areas, and in such cases, it is normally a prerequisite that various types of chemical treatments from fertilizers to herbicides have to be employed in order to grow and maintain such areas to certain standards.

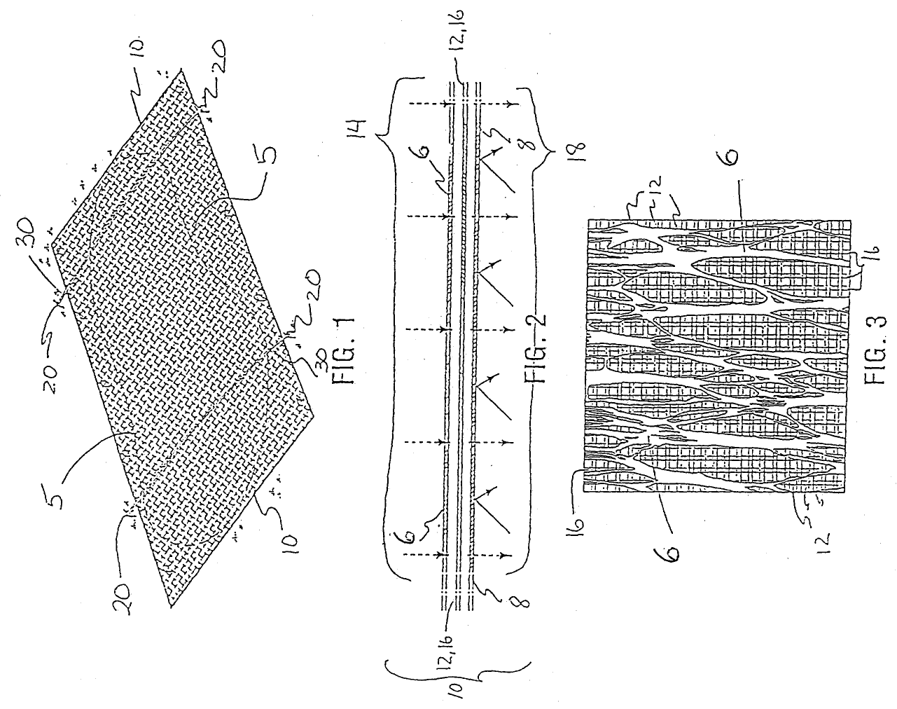

FIG. 1 shows the cover (10) of the present invention in use over a golf green (5). The material is lightweight and flexible which allows for easy manipulation of the cover over a substrate having various dimensions.

The cover (10) may be held in place by suitable securing means such as a series of pins (20) which are spaced apart peripherally around the cover (10). By placement of the pins (20), the cover (10) is releasably secured to the substrate. A pin (20) would typically have a catch mechanism, for example, a hook and be approximately 6″ in length. The pin (20) must also be of a sufficient durability to be forcefully wedged into the substrate while enfolding a portion, or “piercing”, of the cover (10) between the substrate and the outer catch mechanism of the pin. Other securing means such as hooks, wire stakes, etc. may be used to releasably secure the cover (10).

Alternatively, and as shown in FIG. 1, the catch mechanism may comprise a hook, or the like, which receives a rope positioned over the cover (10) and which provides further securement of the cover (10) during adverse weather conditions, for example, high atmospheric winds. If necessary, or if desirable, the cover (10) may be equipped with one or more reinforced apertures, such as an eyelet, to receive the securing means, but also provide efficient releasing means.

Turning now to FIG. 2, a cross-sectional view of the protective cover (10) in use over a golf green is shown. The cover (10) is an open mesh weave of preferably, thermoplastic material, the weave having warp (12) and weft (16) strips forming a substantially thin uniform layer having opposed major surfaces. The strips (12, 16) form individual slits through the opposed surfaces enabling water and air to permeate the cover. The layer is provided on one surface thereof with a heat absorbing lace coating (6) and on the other surface with a heat reflective lace coating (8). The heat absorbing lace coating (6) of the present invention is positioned as the top layer (14) to allow sunlight to permeate through the cover (10) whereas the heat reflective lace coating (8) of the present invention is positioned as the bottom layer (18) trapping moisture, chemicals and heat between the substrate and the protective cover (10).

In forming the product of FIG. 2, polymeric material was applied separately to each face (one being the heat absorbing lace coating and the other a reflective lace coating material) to an extent whereby approximately 35% of each surface of the layer had the coating applied thereon. The coating during application to each face of the layer, was applied in such a manner that overlapping occurred between the lace coating on the top layer and the lace coating on the bottom layer. In this manner, the ultimate product had a total coating coverage of approximately 55% of the open mesh weave material when calculating the amount of coating as if it were applied to one side only. As explained previously, this percentage may vary depending on the intended application of the product.

The product of FIG. 2 is very suitable for use as golf green covers for winter protection and as well, for use in vegetable or crop applications. As will be seen from the test results described hereinafter, significant improvements in soil temperature can be obtained.

FIG. 3 shows a sample portion of the protective cover (10) with the heat absorbing lace coating (6) proceeding linearly over the open mesh weave. The heat reflective lace coating (8) is formed in irregular patterns and streams linearly across the layer in a like manner as the opposing side. The coatings (6)(8) cover between about 5-60% of each surface of the top layer (14) and the bottom layer (18), desirably between about 10 to 40%. The coatings (6)(8) may be applied to the warm layer by suitable conventional techniques such as calendering, spraying, extrusion, etc.

The heat absorbing coating (6) of the top layer (14) comprises a polyolefin polymer which uses a suitable colouring agent for producing the desired absorption of heat. For example, colours from the wavelength spectrum such as green, blue, black, and the like provide suitable means for absorbing ultraviolet rays from the sun and would be used in forming the lace coating (6) for the top layer (14).

Conversely, the bottom layer (18) which is similarly comprised of a polyolefin polymer, for example, polyethylene, uses a colouring agent having heat reflection properties. Thus, colours from the spectrum such as white, silver, gold, bronze, etc. would be used for the lace coating (8) on the bottom layer (18) in order to provide sufficient reflection characteristics for the capture of heat and moisture.

The following description shows the test results of samples prepared according to the prior art, and a sample according to the present invention relative to the improved characteristics of the present invention over the prior art.

For the purposes of the tests showing solar reflectance, IR radiation and air leakage, three replicates of each of three different products, designated product A, product B and product C were prepared. Each product consisted of a rectangular sheet of woven fabric of the type illustrated in FIG. 1, made up of a substantially uniform weave of warp and weft strips, each strip having an approximate dimension of ¼ inch (such strips may vary in width from 1/16th of an inch to ¾ of an inch or more, depending on the intended application). The warp and weft threads can be spaced from adjacent warp and weft threads by approximately ¼ inch (although the gap between adjacent threads or strip may range from 1/16th of an inch to ½ of an inch or more depending on the intended application), thus giving an open weave structure.

The warp and weft threads were formed from polyethylene having a thickness of approximately 1.5 mil.

For Product A, an irregular lace coating was calendered onto one side of the sheet described above, in which the calendaring coating application provided approximately 35% coverage on one surface of the rectangular sheet. The lace coating for Product A had an approximate thickness of 1 mil. (the coating may range in thickness from 0.5 mil. to several mils., e.g. 8 to 10 mils.) covering approximately 35% of the total surface of the rectangular sheet. The lace coating was comprised of polyethylene. Product A was essentially a substantially clear product and had the approximate appearance of one side of the sheet shown in FIG. 3.

Product B had essentially all of the characteristics outlined above for Product A, with the exception that the lace coating was a green coloured polyethylene, thus rendering Product B with approximately 35% of one surface with a medium density green colour.

Product C according to the present invention was constructed in a manner similar to that described above with respect to Product A, except that in Product C, a lace coating was calendered on one side utilizing the same green colouring as that of Product B. On the other opposed face, a lace coating was calendered thereon, which coating had a substantially solid silver colour. The lace coating on each of the opposed faces was calendered to provide approximately 35% coverage on each face of the product; in the product used in these tests, with 35% coverage on each face of the core layer, the effect of the combined lace coatings was to provide approximately 55% total coverage of the combined or total surface area of both faces of the core product. The degree of total coverage will vary depending on how the lace coatings on each face are applied and whether it is desired to create more or less total closure or blockage of the core scrim product.

Each of Products A, B and C were then subjected to the tests described above. In each test, for optical properties, triplicate samples of the same product were evaluated. In the case of the optical properties for solar radiation, the values were calculated from solar reflectance experiments, as follows:

The solar reflectance of each sample was measured in three (3) different places on both faces of each sample. Solar reflectance measurements were made using a Gier Dunkle MS 251 Solar Reflectometer, which has the following specifications:

Accuracy: ±0.02 for gray samples and ±0.04 for wavelength-selective samples

Reproducibility: ±0.005

Sample Size: 0.5 inches minimum

In the case of IR reflectance, the values were obtained by measuring in three (3) different places on both faces of each sample. Measurements were made using a Gier Dunkle DB-100 Infrared Reflectometer, which has the following specifications:

Accuracy: ±0.01 for gray samples and ±0.03 for wavelength-selective samples

Reproducibility: ±0.002

Sample size: 0.9 inches minimum

Since the samples had inhomogeneous surfaces on a scale approximately equal to the size of the measurement ports on the reflectometers use, the three measurement positions on each sample were chosen to represent a position with the highest visible transparency, a position with the lowest visible transparency, and a position with intermediate transparency.

The tests were carried out based on the testing procedures outlined in Section 6.4.1 Air Leakage Testing and Section 6.4.2 Calculation of Air Leakage Rating in the CCMC Technical Guide for Air Barrier Materials Masterformat Section 07273. The details of the test method are contained in Appendix 1 attached hereto.

Subjecting Products A, B and C to the above-noted tests, Tables 1 and 2 show the results and values for the different products. In the case of Product B, the lace coating containing the green pigmented polyethylene formed the top surface when the product was being tested; in Product C according to the present invention, the top surface was the surface having the heat absorbing coating (i.e. the green coloured polyethylene) while the silver coated lace coating formed the outer bottom layer.

TABLE 1
Test for Optical Properties for Solar Radiation

| Sample | Sample | Side I | | | Side II | | |
|---|---|---|---|---|---|---|---|
| Description | Number | ρ | T | α = ε | ρ | T | α = ε |
| Product A | 0.04167 | 0.423 | 0.451 | 0.127 | 0.44 | 0.45 | 0.109 |
| | 1 B | 0.182 | 0.787 | 0.031 | 0.21 | 0.79 | 0 |
| | 1 C | 0.248 | 0.669 | 0.082 | 0.29 | 0.67 | 0.044 |
| | Average | 0.28 | 0.64 | 0.08 | 0.31 | 0.64 | 0.05 |
| Product B | 0.08333 | 0.125 | 0.519 | 0.356 | 0.17 | 0.52 | 0.315 |
| | 2 B | 0.116 | 0.689 | 0.195 | 0.14 | 0.69 | 0.169 |
| | 2 C | 0.178 | 0.817 | 0 | 0.18 | 0.82 | 0 |
| | Average | 0.14 | 0.67 | 0.19 | 0.16 | 0.67 | 0.16 |
| Product C | 0.125 | 0.149 | 0.569 | 0.282 | 0.15 | 0.57 | 0.282 |
| | 3 B | 0.156 | 0.456 | 0.387 | 0.16 | 0.46 | 0.384 |
| | 3 C | 0.15 | 0.437 | 0.413 | 0.24 | 0.44 | 0.327 |
| | Average | 0.15 | 0.49 | 0.36 | 0.18 | 0.49 | 0.33 |

TABLE 2
Test for Optical Properties for Infrared (IR) Radiation

| Sample | Sample | Side I | | | Side II | | |
|---|---|---|---|---|---|---|---|
| Description | Number | ρ | T | α =ε | ρ | T | α = ε |
| Product A | 0.04167 | 0.423 | 0.451 | 0.127 | 0.44 | 0.45 | 0.109 |
| | 1 B | 0.182 | 0.787 | 0.031 | 0.21 | 0.79 | 0 |
| | 1 C | 0.248 | 0.669 | 0.082 | 0.29 | 0.67 | 0.044 |
| | Average | 0.28 | 0.64 | 0.08 | 0.31 | 0.64 | 0.05 |
| Product B | 0.08333 | 0.125 | 0.519 | 0.356 | 0.17 | 0.52 | 0.315 |
| | 2B | 0.116 | 0.689 | 0.195 | 0.14 | 0.69 | 0.169 |
| | 2C | 0.178 | 0.817 | 0 | 0.18 | 0.82 | 0 |
| | Average | 0.14 | 0.67 | 0.19 | 0.16 | 0.67 | 0.16 |
| Product C | 0.125 | 0.149 | 0.569 | 0.282 | 0.15 | 0.57 | 0.282 |
| | 3 B | 0.156 | 0.456 | 0.387 | 0.16 | 0.46 | 0.384 |
| | 3 C | 0.15 | 0.437 | 0.413 | 0.24 | 0.44 | 0.327 |
| | Average | 0.15 | 0.49 | 0.36 | 0.18 | 0.49 | 0.33 |

In the above-noted tables, the reflectance of each sample is listed in the column under the symbol ρ, the transmittance is listed under the symbol τ, and the absorptance is listed in the column heading α=ε. In the case of the infrared radiation measurements, the absorptance is equal to the thermal emittance.

The averages listed in the tables for each type of material represent the average of the sample positions measured, and not necessarily the average over a large area of the materials. The average over a large area of a given material will be between the extremes listed for each A-B-C group.

Results of the air permeability evaluation of the materials are included in Table 3. A pressure of 5 Pa corresponds to the dynamic pressure in a wind of about 10 km per hour.

TABLE 3
Test Results of Air Leakage Evaluation

| Test | Test Pressure diff. | Leakage | Leakage |
|---|---|---|---|
| Specimen | (Pa) | (m³/min/m²) | (ft³/h/ft²) |
| Product A | 5 | 4.36 | 858.2 |
| Product B | 5 | 1.81 | 356.0 |
| Product C | 5 | 2.44 | 481.0 |

As will be seen from the above measurements in Table 3, Product C according to the present invention will transmit approximately 25% less solar energy directly to the ground, absorbing approximately twice as much solar energy as Product B. This is quite significant relative to how much a substrate (i.e. the ground) heats up when the cover of the present invention is not covered with snow. The extra absorption in the product of the present invention will also be useful in melting snow from the cover where the cover is at least partially exposed to sunshine.

In addition, Product C according to the present invention with a bottom layer of heat reflective properties reflects more IR thermal radiation, particularly from the bottom layer compared to the other two products. Product C also absorbs more IR thermal radiation than either of the other two products, which means that the product of the present invention will be more effective in retaining in-ground heat when the heat is in the ground. This will be particularly useful when snow otherwise overlies the cover since the sun would not otherwise be able to warm the ground. Under such conditions, the heat retention properties of the products of the present invention will keep the ground warmer.

It is understood that the cover of the present invention finds ideal use for the covering of golf greens during winter months to prevent damage to the green and enhance revitalization in the spring months. However, it is also apparent the invention has similar beneficial use for other surfaces which require further protection, such as for seed germination.

Those skilled in the art to which the invention pertains understand the invention has been described by way of a detailed description of a preferred embodiment and departures from and variations to this arrangement may be made without departing from the spirit and scope of the invention, as the same is set out and characterized in the accompanying claims.

What is claimed is:

1. A cover for grass protection comprising a composite layer composed of:
an open mesh weave of thermoplastic material, said weave having warp and weft strips forming a substantially thin uniform layer having opposed surfaces, said mesh defining individual slits extending through said layer;
a discontinuous heat absorbing layer on one of said opposed surfaces, and a discontinuous heat reflective layer on the other of said opposed surfaces.

2. The composite layer according to claim 1, wherein said layer on each surface has a thickness of at least 0.5 mil.

3. The composite layer according to claim 1, wherein each said layer covers between about 5 to 60% of each surface of said composite layer.

4. The composite layer according to claim 1, wherein each said layer covers between about 10 to 40% of each surface of said composite layer.

5. The composite layer according to claim 1, wherein the thermoplastic material forming the strips of said composite is a polyolefin.

6. The composite layer according to claim 5, wherein said polyolefin is a polyethylene and said layer is a polyethylene compatible with said polyethylene strip.

7. The composite layer according to claim 1, wherein said layer includes a colouring agent of a wavelength having heat absorption properties.

8. The composite layer according to claim 7, wherein said colouring agent is selected from the colours green, blue, brown and black.

9. The composite layer according to claim 1, wherein said layer includes a colouring agent of a specified wavelength having heat reflective properties.

10. The composite layer according to claim 9, wherein said colouring agent is selected from the colours white, silver, gold and bronze.

11. The composite according to claim 1, wherein said composite layer is of a size to cover a grassed substrate such as a golf course green.

12. The composite layer according to claim 1, wherein said composite is secured over a substrate.

13. The composite layer according to claim 1, wherein said open mesh weave has openings which allow water to permeate therethrough.

14. The composite layer according to claim 1, wherein the layer on each surface of said open mesh weave amounts to a total of 5% to 80% of the combined total surface area of both faces.

15. A method of forming a heat absorbing and heat reflective composite layer comprising the steps of:
providing an opening-mesh weave of thermoplastic material in which the material has warp and weft strips forming a substantially uniform layer and having opposed major surfaces;
said open-mesh weave has openings of a size sufficient to permit the passage of water therethrough;
coating one of said surfaces with a discontinuous or intermittent coating having heat reflective properties; and,
coating the other said surface with a discontinuous or intermittent coating having heat absorbing properties.

16. The method according to claim 15, wherein said coating is extruded onto said open mesh weave.

17. A method for protecting or enhancing turf, lawn, garden or other substrate comprising:
applying to said substrate a protective layer of a composite, said composite comprising:
an open mesh weave of thermoplastic material, said weave having warp and weft strips forming a substantially uniform layer having opposed major surfaces, said layer having on one surface thereof a heat absorbing discontinuous or intermittent coating and on the other surface a heat reflective discontinuous or intermittent coating;
said composite being applied to said substrate with said heat absorption layer forming an outer face and said heat reflective layer being in contact with said substrate;
releasably securing said protective layer to said substrate; and,
removing said protective layer when protection is not desired.

18. The method according to claim 15, wherein said coating covers between about 5 to 60% of each surface of said composite layer.

19. The method according to claim 17, wherein said coating covers between about 10 to 40% of each surface of said composite layer.

20. The method according to claim 17, wherein said coating on each surface of said open mesh weave amounts to a total of 5% to 80% of the combined total surface area of both faces.
